(19) United States
(12) Patent Application Publication
(10) Pub. No.: US 2005/0130862 A1
(43) Pub. Date: Jun. 16, 2005

(54) Copolyesteramides and the use thereof as a soil release agent

(76) Inventors: Lise Trouillet-Fonti, Lyon (FR); Etienne Fleury, Irigny (FR); Cedric Geferoy, Poitiers (FR); Franck Touraud, Vernon (FR)

Correspondence Address: Jean-Louis Seugnet;Intellectual Property Dept./ Rhodia Inc, 259 Prospect Plains Road, CN7500, Cranbury, NJ, 08512-7500, US

(21) Appl. No.: 10/507,557

(22) PCT Filed: Mar. 13, 2003
(86) PCT No.: PCT/FR03/00802

(30) Foreign Application Priority Data
Mar. 15, 2002 (FR) 02/03237

(51) Int. Cl. C11D 1/00; C08F 283/04

(52) U.S. Cl. 510/351; 525/420.5

(57) ABSTRACT

The invention relates to novel water-soluble or water-dispersible sulphonated linear copolymers comprising sulphonated linear polyesteramides and, optionally, sulphonated linear polyester chains and/or polyamides. The invention also relates to the use of said copolymers as a soil release and/or anti-redeposition and/or detergent agent in compositions for treating (washing and/or rinsing, stain removal before washing, drying in a clothes dryer or ironing) articles made from textile fibers, such as polyamide fibers.

A subject matter of the present invention is novel, water-soluble or water-dispersible, linear sulfonated copolymers (linear sulfonated copolyesteramides), their process of preparation and their use as soil release and/or antiredeposition and/or detergent agent in compositions for the treating (washing and/or rinsing, prespotting, drying in a tumble dryer or ironing) of articles made of textile fibers, in particular of polyamide fibers.

Water-soluble or water-dispersible sulfonated poly-esters are known as soil release additives in detergent compositions for washing articles made of polyester-based textile fibers (EP-A-763 068, U.S. Pat. No. 4,877,896, U.S. Pat. No. 5,599,792, WO 93/21294, U.S. Pat. No. 5,415,807, WO 95/02030).

The Applicant Company has found novel copolymers derived from water-soluble or water-dispersible sulfonated polyesters which additionally exhibit an improved effectiveness, in particular as soil release agent, for the washing of textiles made of polyamide fibers, in particular in the presence of nonionic surface-active agents or of a mixture of anionic and nonionic surface-active agents.

A first subject matter of the invention consists of novel water-soluble or water-dispersible linear sulfonated copolymers (C), characterized in that they comprise:
(i) linear polyesteramide chains (C₁), optionally linear polyester chains (C₂) and optionally polyamide chains (C₃),
   (i1) said linear polyesteramide chains (C₁) being essentially composed of
      at least one “esteramide” unit of general formula (I)
         [—C(O)-Q-C(O)—{NR′—W—C(O)}ₘ—(O—R—)ₙ—O—] (I)
         where
the symbol Q represents
   a nonionic mono- or polyarylene or nonionic alkylene residue (NQ),
   or a sulfonated mono- or polyarylene or sulfonated alkylene residue (SQ) carrying at least one sulfonic acid or sulfonate functional group,
R′ is H or an alkylene residue comprising from 1 to 4 carbon atoms,
W is a nonionic alkylene or nonionic arylene residue comprising from 1 to 20 carbon atoms, preferably from 1 to 12 carbon atoms,
R is a linear or branched alkylene residue comprising from 2 to 4 carbon atoms, preferably ethylene,
m is equal to at least 1,
n ranges from 1 to 4;
   and optionally of
      at least one “ester” unit of general formula (II)
         [—C(O)-Q-C(O)—(O—R—)ₙ—O— (II)
         where
the symbols Q, R and n have the definition given above;
   (i2) said optional linear polyester chains (C₂) having the general formula (III)
      [—C(O)-Q-C(O)—(O—R—)ₙ—O—]ₓ (III)
      where
the symbols Q, R and n have the definition given above,
x is greater than 1, the molar percentage of the groups of formula —C(O)-Q-C(O)— where Q is a sulfonated residue (SQ), with respect to the combined units of formula —C(O)-Q-C(O)— in the units or chains of formulae (I), (II) and (III), being from 5 to 40, preferably from 7 to 35;
   (i3) said optional polyamide chains (C₃) having the general formula (IV)
      —{NR′—W—C(O)}_{z}— (IV)
      where:
R′ and W have the definition given above,
z is greater than 1;
and (ii)
   (ii1) , as chain (C₁) ends,
      an “amide” group of formula (V)
         HO—[(O)C—W—NR′)—]ₚ (V)
         where
the symbols W and R′ have the definition given above,
p is equal to at least 1;
   and/or:
      a group of formula (VI1)
         Z-(O—R)ₙ—O— (VI1)
         where:
R and n have the definition given above,
Z represents
   H,
   a sulfobenzoyl group,
   a sulfoalkyl group comprising from 2 to 30 carbon atoms,
   a phenylsulfonate group;
   and/or:
      a group of formula (VII1)
         Y—O— (VII1)
where Y represents H or an alkyl radical comprising from 1 to 30 carbon atoms, preferably methyl;
   and/or:
      a residue —Y, with the definition given above, bonded to an oxygen atom of an ether functional group of the chain (C₁);
   (ii2), as chain (C₂) ends,
      a group of formula (VI2)
         Z-(O—R)ₙ—O— (VI2)
         where:
R, Z and n have the definition given above;
   and/or:
      a group of formula (VII2)
         Y—O— (VII2)
where Y has the definition given above;
   and/or:
      a residue —Y, with the definition given above, bonded to an oxygen atom of an ether functional group of the chain (C₂);
   (ii3) and, as chain (C₃) ends,
      a hydrogen atom bonded to a nitrogen atom of the chain (C₃);
      and a functional group —OH bonded to a carbonyl residue —C(O)— of the chain (C₃);
   said units of the chains (C₁) being
      bonded to one another or to the chain ends (ii1) of formulae (VI1n) and (VII1) by ester bonds;
      bonded to the chain ends (ii1) of formula (V) by amide bonds;
   the chain (C₂) being bonded to the chain ends (ii2) of formulae (VI2) and (VII2) by ester bonds;
   the number of units of formulae (I) and (II) of the chains (C₁), the values of m, of p, of x and of z being such that the weight-average molar mass of said linear sulfonated copolymers (C) is from 500 to 80 000 g/mol, preferably from 1500 to 80 000 g/mol, very particularly from 3000 to 20 000 g/mol;
   the value of m, of m+p, of m+z or of m+p+z, when one or more “amides” groups of formula (V) and/or one or more polyamide chains (C₃) are present, being such that the ratio of the number of —C(O)-Q-C(O)— groups to the number of —(NR′—W—C(O)— groups present in said linear sulfonated copolymers (C) is between 1/99 and 99/1, preferably between 10/90 and 99/1, very particularly between 40/60 and 95/5.

Said linear sulfonated copolymers (C) according to the invention are regarded as water-soluble when soluble to at least 5% by weight in water of pH 7 at 25° C. They are regarded as water-dispersible when they do not form aggregates under these same conditions.

Preferably, the polyesteramide chains (C) are composed essentially of
at least one unit of formula (I′)
   [—C(O)-Q-C(O)—{NR′—W—C(O)}ₘ—(O—CH₂—CH₂—)ₙ—O—] (I′)
   and optionally of
at least one unit of formula (II′)
   [—C(O)-Q-C(O)—(O—CH₂—CH₂—)ₙ—O] (II′)

The groups of formula (V) above and/or of formula (VI′1)
H—(O—CH₂—CH₂—)ₙ— (VI′1)
and/or a hydrogen atom H are present as preferred chain (C₁) ends.

The optional polyester chains (C₂) have the general formula (III′)
[—C(O)-Q-C(O)—(O—CH₂—CH₂—)ₙ—O]ₓ (III′)

The groups of formula (VI′2)
H—(O—CH₂—CH₂—)ₙ—O (VI′2)
and/or a hydrogen atom H are present as preferred optional chain (C₂) ends.

More preferably still, the molar percentage of the residues of formula (O—CH₂—CH₂—)ₙ where n is equal to 1, with respect to the combined residues of formula (O—CH₂—CH₂—)ₙ where n is equal to 1, 2, 3 and 4, in the units or end(s) of formulae (I′), (II′), (VI′1), (III′) and (VI′2) is from 10 to 80, preferably from 20 to 60.

The weight-average molecular masses are measured by gel permeation chromatography, in dichloromethane comprising 2/1000 by volume of trifluoroacetic anhydride and 5×10⁻³M of BF₄N (Bu)₄, at ambient temperature. The results are expressed in polystyrene equivalents.

The nonionic residues (NQ) of the units of formulae (I), (II) and (III) can be alike or different.

Mention may be made, as examples of nonionic residues (NQ), of nonionic C₆-C₁₄ mono- or polyarylene residues and nonionic, linear or branched, C₁-C₉ alkylene residues, such as the 1,4-phenylene, 1,3-phenylene, 1,6-naphthalene, 1,6-cyclohexylene, ethylene, trimethylene, tetramethylene or hexamethylene residues.

The sulfonated residues (SQ) of the units of formulae (I), (II) and (III) can be alike or different.

Mention may be made, as examples of sulfonated residues (SQ), of sulfonated C₆-C₁₄ mono- or polyarylene residues and sulfonated, linear or branched, C₁-C₉ alkylene residues carrying at least one sulfonic acid functional group, preferably in the form of an alkali metal or tetraalkylammonium sulfonate, very particularly a sodium sulfonate, such as the sodiooxysulfonylphenylene, sodiooxysulfonylnaphthalene, sodiooxysulfonylbiphenylene or sodiooxysulfoethylene residues.

Preferably, the nonionic residue (NQ) is a 1,4-phenylene residue (NQ1) or a 1,3-phenylene residue (NQ2) and the sulfonated residue (SQ) is a 5-sodiooxysulfonyl-1,3-phenylene residue.

Very preferably, the nonionic residues (NQ) of the units of formulae (I), (II) and (III) are 1,4-phenylene residues (NQ1) or a mixture of 1,4-phenylene residues (NQ1) and of 1,3-phenylene residues (NQ2), the molar percentage of the units of formula —C(O)-Q-C(O)— where Q is a residue (NQ1), with respect to the combined units of formula —C(O)-Q-C(O)— where Q is a nonionic residue (NQ), being of the order of 50 to 100, preferably of 70 to 90.

Preferably, the symbol R in the formulae (I), (II), (III), (VI1) and (VI2) represents an ethylene residue —CH₂—CH₂—.

Preferably, the symbol W in the formulae (I), (I′), (IV) and (V) represents an ethylene, trimethylene, tetramethylene, pentamethylene, heptamethylene, decamethylene, undecamethylene or phenylene residue.

Preferably, the symbol R′ in the formulae (I), (I′), (IV) and (V) represents H.

The novel linear sulfonated copolymers (C) forming the subject matter of the invention can be obtained by:
insertion/polymerization reaction, in the presence of an insertion/polymerization catalyst, or
aminolysis/acidolysis/polycondensation reaction, in the presence of an aminolysis/acidolysis/polycondensation catalyst, or
ester/amide exchange reaction, in the presence of an ester/amide exchange catalyst,
   in a molten medium
(a) of at least one amino acid or poly(amino acid) (“polyamide”) of formula (VIII) or corresponding lactam
   H—[NR′—W—C(O)—]_{q}OH (VIII)
   where:
W and R′ have the definition given above,
Q ranges from 1 to 200, preferably from 1 to 100;
(b) with a linear sulfonated polyester comprising
   (b1) a polyester chain of general formula (IX)
      [—C(O)-Q-C(O)—(O—R—)ₙ—O]_{y} (IX)
      where:
the symbol Q represents
   a nonionic mono- or polyarylene or nonionic alkylene residue (NQ),
   or a sulfonated mono- or polyarylene or sulfonated alkylene residue (SQ) carrying at least one sulfonic acid or sulfonate functional group,
R is a linear or branched alkylene residue comprising from 2 to 4 carbon atoms, preferably ethylene,
n ranges from 1 to 4,
y is greater than 1;
   and
   (b2), as chain ends, groups of formula (VI2) and/or (VII2) and/or Y given above,
      the molar percentage of the groups of formula —C(O)-Q-C(O)— where Q is a sulfonated residue (SQ), with respect to the combined groups of formula —C(O)-Q-C(O)— in the units of formula (VIII), being from 5 to 40, preferably from 7 to 35;
the values of n and y being such that the weight-average molecular mass of said polyester is greater than 1500 g/mol, preferably between 2000 and 10 000 g/mol;
the relative amounts of amino acid, poly(amino acid) of formula (VIII) or lactam and of linear sulfonated polyester being such that the ratio of the number of —C(O)-Q-C(O)— groups employed via said linear sulfonated polyester to the number of —(NR′—W—C(O)— groups employed via said amino acid or poly(amino acid) of formula (VIII) or lactam is between 1/99 and 99/1, preferably between 10/90 and 99/1, very particularly between 40/60 and 95/5.

The term “insertion/polymerization reaction” is understood to mean the insertion of a lactam corresponding to an amino acid with a structure of formula (VIII) in which q is equal to 1 inside the structure of said linear sulfonated polyester and optionally polymerization of said lactam by ring opening initiated by the chain ends of said linear sulfonated polyester.

The insertion reaction can be illustrated as follows:

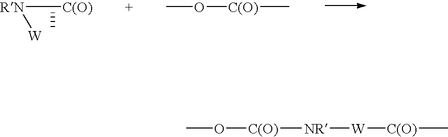

The term “aminolysis/acidolysis/polycondensation reaction” is understood to mean the reaction of an amino acid with a structure of formula (VIII) in which q is equal to 1 with said sulfonated polyester and with itself.

The term “ester/amide exchange reaction” is understood to mean the reaction of an amino acid with a structure of formula (VIII) in which q is greater than 1 with said sulfonated polyester.

The reaction between said amino acid, poly(amino acid) or lactam and said linear sulfonated polyester is carried out in a molten medium at a temperature which can favorably range from 220 to 280° C., more preferably around 250° C., under a pressure of 1 to 3 bar, preferably of 1 bar.

Said reaction can be carried out in the absence or in the presence of a catalyst, in an amount which can range up to 0.2% by weight with respect to the total amount of reactants employed.

The catalysts which can be employed are in particular zinc, phosphorus, tin, antimony or sulfur derivatives, such as zinc acetate, hypophosphorous acid, ortho-phosphorous acid, tin dibutyldilaurate, antimony trioxide or p-toluenesulfonic acid; very preferably, they are zinc acetate and hypophosphorous acid.

The reaction can last from 1 hour to 10 hours when it is carried out in a conventional polymerization reactor; it can last from 10 seconds to 10 minutes when it is carried out in an extrusion device (screw, for example).

Insertion/polymerization is a particularly advantageous method for the preparation of the linear sulfonated copolymers of the invention.

Preferably, the level of water in the reaction medium is less than 5%, more preferably still less than 1%, by weight.

Mention may be made, among the amino acids, poly(amino acid)s or lactams which can be employed, of
β-propiolactam, γ-butyrolactam, δ-valerolactam, ε-caprolactam, η-caprylolactam, the lactam of ω-amino-undecanoic acid, and the corresponding amino acids,
para- and meta-aminobenzoic acids,
polyamide 6, polyamide 8, polyamide 12, and their copolymers, with a degree of polymerization ranging from 2 to 200, preferably from 2 to 100.

Mention may in particular be made, among the linear sulfonated polyesters which can be employed, of those forming the subject matter of EP-A-763 068, U.S. Pat. No. 4,877,896, U.S. Pat. No. 5,599,792, WO 93/21294, U.S. Pat. No. 5,415,807 and WO 95/02030.

According to a preferred embodiment, the linear sulfonated polyester employed comprises:
a polyester chain of general formula (IX′)
   [—C(O)-Q-C(O)—(O—CH₂—CH₂—)ₙ—O]_{y} (IX′)
and
, as chain ends, groups of formula (VI′2)
   H—(O—CH₂—CH₂—)ₙ—O— (VI′2)
and H.

More preferably still, the molar percentage of the residues of formula (O—CH₂—CH₂—)ₙ where n is equal to 1, with respect to the combined residues of formula (O—CH₂—CH₂—)ₙ where n is equal to 1, 2, 3 and 4, in the chains or end(s) of formulae (IX′) and (VI′2) is of the order of 10 to 80, preferably of the order of 20 to 60.

The linear sulfonated polyesters employed in preparing the novel linear sulfonated copolymers (C) of the invention are known products.

Thus, the linear sulfonated polyesters exhibiting groups of formula (VI′2) and H as chain ends can be obtained in a known way, for example by esterification and/or transesterification in the presence of an esterification/transesterification catalyst and poly-condensation in the presence of a polycondensation catalyst of a monomer composition composed essentially of:
a nonsulfonated diacid monomer (MNQ) composed of at least one aromatic or aliphatic dicarboxylic acid or anhydride or their diesters, in an amount corresponding to an (MNQ)/(MNQ)+(MSQ) molar ratio of the order of 95/100 to 60/100, preferably of the order of 93/100 to 65/100
a sulfonated diacid monomer (MSQ) composed of at least one sulfonated aromatic or sulfonated aliphatic dicarboxylic acid or anhydride or their diesters, in an amount corresponding to an (MSQ)/(MNQ)+(MSQ) molar ratio of the order of 5/100 to 40/100, preferably of the order of 7/100 to 35/100
and a polyol monomer (P) composed of diol HO—R—OH and optionally of diol HO—R—O—R—OH (preferably of ethylene glycol and optionally of diethylene glycol), according to an amount corresponding to a ratio of number of OH functional groups of the polyol monomer (P) to number of COOH functional groups or functional group equivalents of the diacid monomers (MNQ)+(MSQ) of the order of 1.05 to 4, preferably of the order of 1.1 to 3.5 and very particularly of the order of 1.8 to 3.

The basic entity considered in the definition of the mole of monomer (MNQ) or (MSQ) is the COOH functional group in the case of the diacids or the COOH functional group equivalent in the case of the anhydrides or the diesters.

Mention may be made, among nonsulfonated diacid monomers (MNQ), of terephthalic, isophthalic, 2,6-naphthalenedicarboxylic, cyclohexanedicarboxylic, succinic, glutaric, adipic or suberic acids, their anhydrides or their lower diesters.

The nonsulfonated diacid monomer (MNQ) is preferably composed of 50 to 100 mol %, very particularly of 70 to 90 mol %, of terephthalic acid or anhydride or of one of its lower diesters (methyl, ethyl, propyl, isopropyl, butyl) and of 0 to 50 mol %, very particularly of 10 to 30 mol %, of isophthalic acid or anhydride or of one of its lower diesters (methyl, ethyl, propyl, isopropyl, butyl); the preferred diesters are those of methyl.

The sulfonated diacid monomer (MSQ) exhibits at least one sulfonic acid group, preferably in the form of an alkali metal or tetraalkylammonium sulfonate (preferably sodium sulfonate), and two acid functional groups or acid functional group equivalents (that is to say, one anhydride functional group or two ester functional groups) attached to one or more aromatic rings when said monomer is aromatic.

In the case of a sulfonated aliphatic diacid monomer, the sulfonic acid group can be bonded to a carbon atom of an alkylene radical, either directly or indirectly via an alkylene, alkoxyalkylene, oxyalkylene, aryl-alkylene, alkylarylalkylene or alkoxyarylene group.

Mention may be made, among sulfonated diacid monomers (MSQ), of sulfonated aromatic or aliphatic dicarboxylic acids, such as sulfoisophthalic, sulfoterephthalic, sulfoorthophthalic, 4-sulfonaphthalene-2,7-dicarboxylic, sulfodiphenyldicarboxylic or sulfosuccinic acids, their anhydrides or their lower diesters. The preferred sulfonated diacid monomers (MSQ) are sulfoisophthalic acids or anhydrides and their dimethyl esters and very particularly dimethyl 5-(sodiooxysulfonyl)isophthalate.

The preferred sulfonated polyesters can be obtained from:
terephthalic acid (MNQ1) in the diester form (preferably the methyl form), optionally as a mixture with isophthalic acid and/or terephthalic acid (MNQ2) in the diacid or anhydride form, according to an (MNQ1)/(MNQ1)+(MNQ2) molar ratio of the order of 100/100 to 50/100, preferably of the order of 90/100 to 70/100,
a 5-(sodiooxysulfonyl)sulfoisophthalic acid, in the diester form (preferably the methyl form),
monoethylene glycol.

They can be prepared by carrying out the following successive stages:
a stage of transesterification (interexchange) between, on the one hand, the diester (preferably dimethyl ester) of terephthalic acid (MNQ1) and the diester (preferably dimethyl ester) of sulfoisophthalic acid (MSQ) and, on the other hand, monoethylene glycol (P), the ratio of number of OH functional groups of (P) to number of COOH functional group equivalents of (MNQ1)+(MSQ) being of the order of 1.05 to 4, preferably of the order of 1.1 to 3.5 and very particularly of the order of 1.8 to 3,
a stage of esterification between isophthalic acid and/or terephthalic acid (MNQ2) and, on the other hand, monoethylene glycol (P), the ratio of number of OH functional groups of (P) to number of COOH functional groups of (MNQ2) being of the order of 1.05 to 4, preferably of the order of 1.1 to 3.5 and very particularly of the order of 1.8 to 3,
a stage of polycondensation.

The operating conditions of the transesterification, esterification and condensation stages which can be carried out are those disclosed in WO 95/32997.

Chain ends of formula of the type (VI2) where the symbol Z represents a sulfobenzoyl group can be obtained by employing, preferably in the esterification stage, sulfonated monoacid monomers, such as m-sodiosulfobenzoic acid, methyl m-sodiosulfobenzoate or 2-hydroxyethyl m-sodiosulfobenzoate.

The linear sulfonated copolymers (C) forming the subject matter of the invention can be used as soil release and/or antiredeposition and/or detergent agents in compositions for the treatment of articles made of textile fibers, preferably based on synthetic polymer (polyamide and polyester, for example), said compositions being intended to be employed in an operation in which said articles are washed and/or rinsed, prespotted, dried in a tumble dryer or ironed.

Said copolymers are particularly advantageous as soil release agents for washing and/or rinsing, prespotting, drying in a tumble dryer or ironing articles made of polyamide fibers.

A second subject-matter of the invention consists of a composition for the treatment of articles made of textile fibers, intended to be employed in an operation in which said articles are washed and/or rinsed, prespotted, dried in a tumble dryer or ironed, comprising from 0.01 to 70%, preferably from 0.05 to 30%, with respect to the weight of said compositions, of at least one water-soluble or water-dispersible linear sulfonated copolymer (C) described above.

The composition and the conditions for use (or for treatment) can take many forms.

Said composition can be provided
in the form of a solid (powder, granules, tablets, and the like) or of a concentrated aqueous solution or dispersion brought into contact with the articles to be treated after dilution in water;
in the form of a concentrated aqueous solution or dispersion deposited beforehand on the dry articles to be treated before dilution in water;
in the form of an aqueous solution or dispersion to be deposited directly on the dry articles to be treated without dilution or of a solid support (stick) comprising said linear sulfonated copolymer (C) to be applied directly to the dry articles to be treated;
in the form of an insoluble solid support comprising said linear sulfonated copolymer (C) brought directly into contact with the articles to be treated in the wet state.

Thus, the composition according to the invention can be:
a solid or liquid detergent formulation capable of directly forming a detergent bath by dilution;
a liquid rinsing formulation capable of directly forming a rinsing bath by dilution;
a solid material, in particular a textile material, comprising said linear sulfonated copolymer (C) intended to be brought into contact with wet articles in a tumble dryer (said solid material is referred to subsequently as “drying additive”);
an aqueous ironing formulation;
a washing additive (prespotter) intended to be deposited on dry articles prior to a washing operation using a detergent formulation which may or may not comprise said linear sulfonated copolymer (C) (said additive is referred to subsequently as “prespotter”).

The operating pH of the composition according to the invention can range from approximately 2 to approximately 12, according to the use desired.

When it concerns
a detergent formulation, the pH of the detergent bath is generally of the order of 7 to 11, preferably of 8 to 10.5;
a rinsing formulation, the pH of the rinsing bath is generally of the order of 2 to 8;
a drying additive, the pH to be considered is that of the residual water, which can be of the order of 2 to 9;
an aqueous ironing formulation, the pH of said formulation is generally of the order of 5 to 9;
a prespotter, the pH to be considered is that of the pH of the detergent bath of the following washing operation, namely of the order of 7 to 11, preferably of 8 to 10.5.

The amount of copolymer (C) which can be employed depends on the application desired.

Thus, said copolymer (C) can be employed as follows:

| % of (C) | In a composition according to |
|---|---|
| (on a dry basis) | the invention, intended |
| 0.01-10 | for washing |
| preferably 0.1-1 | |
| 0.01-10 | for rinsing |
| preferably 0.1-5 | |
| 0.01-10 | for prespotting |
| preferably 0.05-3 | |
| 0.01-50 | for ironing |
| preferably 0.1-5 | |
| 0.01-70 | for drying in a tumble dryer |
| preferably 0.1-30 | |

Other constituents can be present, apart from the copolymer (C), in the composition according to the invention. Said composition can comprise at least one surface-active agent and/or one detergency and/or rinsing and/or ironing additive for articles made of textile fibers and/or one solid support (in particular textile support) for said copolymer (C). Preferably, said composition comprises at least one anionic surface-active agent or a mixture of anionic and nonionic surface-active agents.

The nature of these constituents depends on the use desired for said composition.

Thus, when it concerns a detergent formulation for washing the laundry, this formulation generally comprises:
at least one natural and/or synthetic surface-active agent,
at least one detergency adjuvant (builder),
optionally an oxidizing agent or system,
and a series of specific additives.

The detergent formulation can comprise surface-active agents in an amount corresponding to approximately 3 to 40% by weight with respect to the detergent formulation, surface-active agents such as

Anionic Surface-Active Agents

alkyl ester sulfonates of formula R—CH(SO₃M)-COOR′, where R represents a C₈₋₂₀, preferably C₁₀-C₆, alkyl radical, R′ a C₁-C₆, preferably C₁-C₃, alkyl radical and M an alkali metal cation (sodium, potassium or lithium), a substituted or unsubstituted ammonium (methyl-, dimethyl-, trimethyl- or tetramethylammonium, dimethylpiperidinium, and the like) cation or a cation derived from an alkanolamine (monoethanolamine, diethanolamine, triethanolamine, and the like). Mention may very particularly be made of the methyl ester sulfonates for which the R radical is a C₁₄-C₁₆ radical;
alkyl sulfates of formula ROSO₃M, where R represents a C₅-C₂₄, preferably C₁₀-C₁₈, alkyl or hydroxyalkyl radical, M representing a hydrogen atom or a cation with the same definition as above, and their ethoxylated (EO) and/or propoxylated (PO) derivatives exhibiting an average of 0.5 to 30, preferably of 0.5 to 10, EO and/or PO units;
alkylamide sulfates of formula RCONHR′OSO₃M, where R represents a C₂-C₂₂, preferably C₆-C₂₀, alkyl radical, R′ represents a C₂-C₃ alkyl radical, M representing a hydrogen atom or a cation with the same definition as above, and their ethoxylated (EO) and/or propoxylated (PO) derivatives exhibiting an average of 0.5 to 60 EO and/or PO units;
salts of saturated or unsaturated C₈-C₂₄, preferably C₁₄-C₂₀, fatty acids, C₉-C₂₀ alkylbenzenesulfonates, primary or secondary C₈-C₂₂ alkylsulfonates, alkylglycerol sulfonates, the sulfonated polycarboxylic acids disclosed in GB-A-1 082 179, paraffin sulfonates, N-acyl-N-alkyltaurates, alkyl phosphates, isethionates, alkylsuccinamates, alkylsulfosuccinates, the monoesters or diesters of sulfosuccinates, N-acylsarcosinates, alkylglycoside sulfates or polyethoxycarboxylates; the cation being an alkali metal (sodium, potassium, lithium), a substituted or unsubstituted ammonium residue (methyl-, dimethyl-, trimethyl- or tetramethylammonium, dimethylpiperidinium, and the like) or a residue derived from an alkanolamine (monoethanolamine, diethanolamine, triethanolamine, and the like).
   Nonionic Surface-Active Agents
polyoxyalkylenated (polyoxyethylenated, polyoxy-propylenated or polyoxybutylenated) alkylphenols, the alkyl substituent of which is C₆-C₁₂, comprising from 5 to 25 oxyalkylene units; mention may be made, by way of example, of Triton X-45, Triton X-114, Triton X-100 or Triton X-102, sold by Röhm & Haas Co.;
glucosamides, glucamides or glycerolamides;
polyoxyalkylenated C₈-C₂₂ aliphatic alcohols comprising from 1 to 25 oxyalkylene (oxyethylene or oxypropylene) units; mention may be made, by way of example, of Tergitol 15-S-9 or Tergitol 24-L-6 NMW, sold by Union Carbide Corp., Neodol 45-9, Neodol 23-65, Neodol 45-7 or Neodol 45-4, sold by Shell Chemical Co., or Kyro EOB, sold by The Procter & Gamble Co.;
the products resulting from the condensation of ethylene oxide, the compound resulting from the condensation of propylene oxide with propylene glycol, such as the Pluronics sold by BASF;
the products resulting from the condensation of ethylene oxide, the compound resulting from the condensation of propylene oxide with ethylenediamine, such as the Tetronics sold by BASF;
amine oxides, such as (C₁ₒ-C₁₈ alkyl)dimethylamine oxides or (C₈-C₂₂ alkoxy)ethyldihydroxyethylamine oxides;
the alkylpolyglycosides disclosed in U.S. Pat. No. 4,565,647;
C₈-C₂₀ fatty acid amides;
ethoxylated fatty acids;
ethoxylated fatty amides;
ethoxylated amines.
   Amphoteric and Zwitterionic Surface-Active Agents
alkyl dimethyl betaines, alkyl amidopropyldimethyl betaines, alkyl trimethyl sulfobetaines, or the condensation products of fatty acids and of protein hydrolysates;
alkyl amphoacetates or alkyl amphodiacetates in which the alkyl group comprises from 6 to 20 carbon atoms.

Builders which improve the properties of the surface-active agents can be employed in amounts corresponding to approximately 5-50%, preferably to approximately 5-30%, by weight for the liquid detergent formulations or to approximately 10-80%, preferably 15-50%, by weight for the powder detergent formulations, builders such as:

Inorganic Builders

alkali metal, ammonium or alkanolamine polyphosphates (tripolyphosphates, pyrophosphates, orthophosphates or hexametaphosphates);
tetraborates or borate precursors;
silicates, in particular those exhibiting an SiO₂/Na₂O ratio of the order of 1.6/1 to 3.2/1, and the lamellar silicates disclosed in U.S. Pat. No. 4,664,839;
alkali metal or alkaline earth metal carbonates (bicarbonates or sesquicarbonates);
cogranules of hydrated alkali metal silicates and of alkali metal carbonates (sodium carbonate or potassium carbonate) which are rich in silicon atoms in the Q2 or Q3 form, which are disclosed in EP-A-488 868;
crystalline or amorphous alkali metal (sodium or potassium) or ammonium aluminosilicates, such as zeolites A, P, X, and the like; zeolite A with a particle size of the order of 0.1-10 micrometers is preferred.
   Organic Builders
water-soluble polyphosphonates (ethane-1-hydroxy-1,1-diphosphonates, salts of methylenediphosphonates, and the like);
water-soluble salts of carboxyl polymers or copolymers or their water-soluble salts, such as:
   polycarboxylate ethers (oxydisuccinic acid and its salts, tartrate monosuccinic acid and its salts, or tartrate disuccinic acid and its salts);
   hydroxypolycarboxylate ethers;
   citric acid and its salts, mellitic acid or succinic acid and their salts;
   salts of polyacetic acids (ethylenediamine-tetraacetates, nitrilotriacetates or N-(2-hydroxy-ethyl)nitrilodiacetates);
   (C₅-C₂₀ alkyl)succinic acids and their salts
   (C₅-C₂₀ alkyl)succinic acids and their salts (2-dodecenylsuccinates or laurylsuccinates);
   polyacetal carboxylic esters;
   polyaspartic acid, polyglutamic acid and their salts;
   polyimides derived from the polycondensation of aspartic acid and/or of glutamic acid;
   polycarboxymethylated derivatives of glutamic acid or of other amino acids.

The detergent formulation can additionally comprise at least one oxygen-releasing bleaching agent comprising a percompound, preferably a persalt.

Said bleaching agent can be present in an amount corresponding to approximately 1 to 30%, preferably from 4 to 20%, by weight with respect to the detergent formulation.

Mention may appropriately be made, as examples of percompounds capable of being used as bleaching agents, in particular of perborates, such as sodium perborate monohydrate or tetrahydrate; or peroxygenated compounds, such as sodium carbonate peroxohydrate, pyrophosphate peroxohydrate, urea hydrogen peroxide, sodium peroxide or sodium persulfate.

The preferred bleaching agents are sodium perborate mono- or tetrahydrate and/or sodium carbonate peroxohydrate.

Said agents are generally used in combination with a bleaching activator generating in situ, in the detergent medium, a peroxycarboxylic acid, in an amount corresponding to approximately 0.1 to 12%, preferably from 0.5 to 8%, by weight with respect to the detergent formulation. Mention may be made, among these activators, of tetraacetylethylenediamine, tetraacetyl-methylenediamine, tetraacetylglycoluril, sodium p-acetoxybenzenesulfonate, pentaacetylglucose or octaacetyllactose.

Non-oxygenated bleaching agents, which act by photo-activation in the presence of oxygen, may also be mentioned, agents such as sulfonated zinc and/or aluminum phthalocyanines.

The detergent formulation can additionally comprise other soil release agents, other antiredeposition agents, chelating agents, dispersing agents, fluorescence agents, foam-suppressant agents, softeners, enzymes and various other additives.

Soil Release Agents

They can be employed in amounts of approximately 0.01-10%, preferably approximately 0.1-5% and more preferably of the order of 0.2-3% by weight.

Mention may more particularly be made of agents such as:
cellulose derivatives, such as cellulose hydroxy ethers, methylcellulose, ethylcellulose, hydroxypropyl methylcellulose or hydroxybutyl methylcellulose;
poly(vinyl ester)s grafted onto polyalkylene back-bones, such as poly(vinyl acetate)s grafted onto polyoxyethylene backbones (EP-A-219 048);
poly(vinyl alcohol)s;
polyester copolymers based on ethylene terephthalate and/or propylene terephthalate and polyoxyethylene terephthalate units, with an ethylene terephthalate and/or propylene terephthalate (number of units)/polyoxyethylene terephthalate (number of units) molar ratio of the order of 1/10 to 10/1, preferably of the order of 1/1 to 9/1, the polyoxyethylene terephthalates exhibiting polyoxyethylene units having a molecular weight of the order of 300 to 5000, preferably of the order of 600 to 5000 (U.S. Pat. No. 3,959,230, U.S. Pat. No. 3,893,929, U.S. Pat. No. 4,116,896, U.S. Pat. No. 4,702,857 and U.S. Pat. No. 4,770666);
sulfonated polyester oligomers, obtained by sulfonation of an oligomer derived from ethoxylated allyl alcohol, from dimethyl terephthalate and from 1,2-propylenediol, exhibiting from 1 to 4 sulfonated groups (U.S. Pat. No. 4,968,451);
polyester copolymers based on propylene terephthalate and polyoxyethylene terephthalate units which are terminated by ethyl or methyl units (U.S. Pat. No. 4,711,730) or polyester oligomers which are terminated by alkylpolyethoxy groups (U.S. Pat. No. 4,702,857) or anionic sulfopolyethoxy (U.S. Pat. No. 4,721,580) or sulfoaroyl (U.S. Pat. No. 4,877,896) groups;
sulfonated polyester copolymers derived from terephthalic, isophthalic and sulfoisophthalic acid, anhydride or diester and from a diol (FR-A-2 720 399).
   Antiredeposition Agents

They can be employed in amounts generally of approximately 0.01-10% by weight for a powder detergent formulation and of approximately 0.01-5% by weight for a liquid detergent formulation.

Mention may in particular be made of agents such as:
ethoxylated monoamines or polyamines, or polymers of ethoxylated amines (U.S. Pat. No. 4,597,898, EP-A-11 984);
carboxymethylcellulose;
sulfonated polyester oligomers obtained by condensation of isophthalic acid, of dimethyl sulfosuccinate and of diethylene glycol (FR-A-2 236 926);
polyvinylpyrrolidones;
   Chelating Agents

Iron- and magnesium-chelating agents can be present in amounts of the order of 0.1-10%, preferably of the order of 0.1-3%, by weight.

Mention may be made, inter alia, of:
aminocarboxylates, such as ethylenediaminetetra-acetates, hydroxyethylethylenediaminetriacetates or nitrilotriacetates;
aminophosphonates, such as nitrilotris(methylene-phosphonates);
polyfunctional aromatic compounds, such as dihydroxy-disulfobenzenes.
   Polymeric Dispersing Agents

They can be present in an amount of the order of 0.1-7% by weight, in order to control the calcium and magnesium hardness, agents such as
water-soluble salts of polycarboxylic acids with a molecular mass of the order of 2000 to 100 000, obtained by polymerization or copolymerization of ethylenically unsaturated carboxylic acids, such as acrylic acid, maleic acid or, anhydride, fumaric acid, itaconic acid, aconitic acid, mesaconic acid, citraconic acid or methylenemalonic acid, and very particularly polyacrylates with a molecular mass of the order of 2000 to 10 000 (U.S. Pat. No. 3,308,067) or copolymers of acrylic acid and of maleic anhydride with a molecular mass of the order of 5000 to 75 000 (EP-A-66 915);
poly(ethylene glycol)s with a molecular mass of the order of 1000 to 50 000.
   Fluorescence Agents (Brighteners)

They can be present in an amount of approximately 0.05-1.2% by weight, agents such as derivatives of stilbene, pyrazoline, coumarin, fumaric acid, cinnamic acid, azoles, methinecyanines, thiophenes, and the like (“The Production and Application of Fluorescent Brightening Agents”, M. Zahradnik, published by John Wiley & Sons, New York, 1982).

Foam-Suppressant Agents

They can be present in amounts which can range up to 5% by weight, agents such as:
C₁₀-C₂₄ fatty monocarboxylic acids or their alkali metal, ammonium or alkanolamine salts, or fatty acid triglycerides;
saturated or unsaturated, aliphatic, alicyclic, aromatic or heterocyclic hydrocarbons, such as paraffins or waxes;
N-alkylaminotriazines;
monostearyl phosphates or monostearyl alcohol phosphates;
polyorganosiloxane oils or resins, optionally combined with silica particles.
   Softeners

They can be present in amounts of approximately 0.5-10% by weight, softeners such as clays.

Enzymes

They can be present in an amount which can range up to 5 mg by weight, preferably of the order of 0.05-3 mg, of active enzyme/g of detergent formulation, enzymes such as:
proteases, amylases, lipases, cellulases or peroxydases (U.S. Pat. No. 3,553,139, U.S. Pat. No. 4,101,457, U.S. Pat. No. 4,507,219 and U.S. Pat. No. 4,261,868);
   Other Additives

Mention may be made, inter alia, of:
buffer agents;
fragrances;
pigments.

The washing formulation can be employed, in particular in a washing machine, in a proportion of 0.5 g/l to 20 g/l, preferably of 2 g/l to 10 g/l, for carrying out washing operations at a temperature of the order of 25 to 90° C.

When it concerns a liquid aqueous formulation for rinsing the laundry, other constituents can be present apart from the copolymer (C), of the type
combinations of cationic surface-active agents (triethanolamine diester quaternized by dimethyl sulfate, N-methylimidazoline tallow ester methyl sulfate, dialkyldimethylammonium chloride, alkylbenzyl-dimethylammonium chloride, alkylimidazolinium methyl sulfate, methylbis(alkylamidoethyl)(2-hydroxyethyl)-ammonium methyl sulfate, and the like) in an amount which can range from 3 to 50%, preferably from 4 to 30%, of said formulation, optionally in combination with nonionic surfactants (ethoxylated fatty alcohols, ethoxylated alkylphenols, and the like) in an amount which can range up to 3%;
polyorganosiloxanes (0.1 to 10%);
fluorescent whitening agents (0.1 to 0.2%);
optionally color-fast agents (polyvinylpyrrolidone, polyvinyloxazolidone, polymethacrylamide, and the like, 0.03 to 25%, preferably 0.1 to 15%);
colorants;
fragrances;
solvents, in particular alcohols (methanol, ethanol, propanol, isopropanol, ethylene glycol, glycerol);
foam limiters.

The rinsing formulation employed, in particular in a washing machine, in a proportion of 0.2 to 10 g/l, preferably of 2 to 10 g/l.

When it concerns a drying additive for the laundry in an appropriate drying machine, said additive comprises a flexible solid support composed, for example, of a strip of woven or nonwoven textile or a sheet of cellulose impregnated with said copolymer (C); said additive is introduced in drying into the wet laundry to be dried at a temperature of the order of 50 to 80° C. for 10 to 60 minutes.

Said additive can additionally comprise cationic softeners (up to 99%) and color-fast agents (up to 80%), such as those mentioned above.

When it concerns an ironing formulation, the latter which can be sprayed directly onto the dry laundry before the ironing operation.

Said ironing formulation can additionally comprise nonionic surface-active agents (from 0.5 to 5%), anionic surface-active agents (from 0.5 to 5%), fragrances (0.1 to 3%) or cellulose derivatives (0.1 to 3%), such as starch.

When it concerns a prespotter, the latter is provided in the form of an aqueous dispersion or of a solid (stick).

Other constituents apart from the copolymer (C) can be present, of the type
anionic surfactants, such as those already mentioned above, in an amount of at least 5% of the weight of the composition;
nonionic surfactants, such as those already mentioned above, in an amount which can range from 15% to 40% of the weight of the composition;
aliphatic hydrocarbons, in an amount which can range from 5% to 20% of the weight of the composition.

A third subject matter of the invention consists of the use, in a composition for the treatment of articles made of textile fibers intended to be employed in an operation in which said articles are washed and/or rinsed, prespotted, dried in a tumble dryer or ironed, of at least one linear sulfonated copolymer (C) described above as soil release and/or antiredeposition and/or detergent agent.

The amount of copolymer (C) to be employed and the treatment conditions have already been mentioned above; it is the same for the nature and for the amount of the various constituents of the treatment composition.

A fourth subject matter of the invention consists of a process for improving the properties of a composition intended for washing and/or rinsing, prespotting, drying in a tumble dryer or ironing said articles made of textile fibers by addition to said composition of at least one linear sulfonated copolymer (C) described above in an amount which is effective in contributing soil release and/or antiredeposition and/or detergency properties to said compositions.

The amount of copolymer (C) to be employed and the treatment conditions have already been mentioned above; it is the same for the nature and for the amount of the various constituents of the treatment composition.

The following examples are given by way of illustration.

Analyses and Measurements

The analyses by ¹H NMR spectroscopy were carried out on a Bruker AMX 300 spectrometer at 300 MHz and at ambient temperature in deuterated trifluoroacetic acid (d-TFA).

The weight-average molar mass is determined as follows by Gel Permeation Chromatography:

The measurement is carried out in a dichloromethane+2/1000 (by volume) trifluoroacetic anhydride+0.005M BF₄N(Bu)₄ mixture at ambient temperature.

The characteristics of the apparatus are as follows:
Chromatographic columns: 3 ultra-high-mass mixed Phenomenex columns, 5 μm precolumn, diameter ⅜′, length 60 cm
Injector pump: Waters Alliance
Detectors: (1) Refractometer: ERMA RI, sensitivity 16; (2) UV absorption: UV2000 TSP dual wavelength, λ=270 nm (1 OD) and λ=330 (1 OD) and (3) Viscometer: homemade with capillary pressure reduction and correction of the flow effects.
Flow rate: 1.5 ml/minute

The solution injected (100 μl) comprises approximately 0.5% (x mg/y ml of solvent) of linear sulfonated copolymer dissolved in a 95% dichloromethane, 5% TFAA, 0.005M BF₄N(Bu)₄ and 2/1000 toluene mixture. The molar masses are given in polystyrene equivalents.

### EXAMPLE I

Synthesis of a linear sulfonated copolymer PEA1 from
ε-caprolactam and
a sulfonated polyester (PES1) with a weight-average molar mass of 3920 and of mean formula
   H—(O—CH₂—CH₂—)ₙ—[—O—C(O)-Q-C(O)—(O—CH₂—CH₂—)ₙ—]_{y}H
   with minor amounts of sulfonated polyester of mean formula
   H—[—O—C(O)-Q-C(O)—(O—CH₂—CH₂—)ₙ—]_{y}H
   in which formulae
n is equal to 1.6
y is equal to 8
Q is composed of:
   83 mol % of a 1,4-phenylene residue
   3 mol % of a 1,3-phenylene residue
   and 15 mol % of a 5-(sodiooxysulfonyl)-1,3-phenylene residue.

22.4 g of E-caprolactam and 37.4 g of the sulfonated polyester (PES1) are introduced into a reactor equipped with a mechanical stirrer (anchor type) and with a reflux condenser and heated by a thermally regulated Wood's alloy bath. After purging with argon, the medium is brought to 100° C. After starting to stir (45 revolutions/minute), 50 μl of a 50% hypophosphorous acid solution in water are added. The reactor is placed under an argon blanket; the medium is brought to 250° C. at the rate of a temperature rise of 4° C. per minute. After stirring at 250° C. for 7 h, the contents of the reactor are poured onto a Teflon (polytetrafluoro-ethylene) sheet.

The linear sulfonated copolymer PEAl obtained exhibits a weight-average molar mass of 5030 g/mol, determined by gel permeation chromatography. Its analysis by ¹H NMR spectroscopy showed that it comprises polyamide 6 blocks with a mean degree of polymerization of 1.7, distributed at 41% in the form of chain ends of type (V) and 59% in the form of “esteramide” units (I) and that the ratio by weight of the residues resulting from the sulfonated polyester (PES1) to the residues resulting from the ε-caprolactam in the copolymer PEA1 is 66/34.

### EXAMPLE II

The operation described in example I is repeated, starting from 13.8 g of ε-caprolcatam, 46.2 g of sulfonated polyester (PES1) and 32 μl of 50% hypophosphorous acid solution in water.

The weight-average molar mass of the linear sulfonated copolymer PEA2 obtained is 4110 g/mol. The mean degree of polymerization of the polyamide 6 blocks is 1.35. The polyamide 6 blocks are distributed 45% in the form of chain ends of type (V) and 55% in the form of “esteramide” units (I) and the ratio by weight of the residues resulting from the sulfonated polyester (PES1) to the residues resulting from the ε-caprolactam in the copolymer PEA2 is 78/22.

### EXAMPLE III

The operation described in example I is repeated, starting from 7.8 g of ε-caprolactam, 52.2 g of sulfonated polyester (PES1) and 20 μl of 50% hypophosphorous acid solution in water.

The weight-average molar mass of the linear sulfonated copolymer PEA3 obtained is 4710 g/mol. The mean degree of polymerization of the polyamide 6 blocks is 1.28. The polyamide 6 blocks are distributed 45% in the form of chain ends of type (V) and 55% in the form of “esteramide” units (I) and the ratio by weight of the residues resulting from the sulfonated polyester (PES1) to the residues resulting from the ε-caprolactam in the copolymer PEA3 is 88/12.

### EXAMPLE IV

Synthesis of a linear sulfonated copolymer PEA4 from polyamide 6 (weight-average molar mass of 42 000 g/mol) and from sulfonated polyester (PES1).

22.5 g of sulfonated polyester (PES1), 7.5 g of polyamide 6 and 32 mg of zinc acetate dihydrate are introduced into a reactor equipped with a mechanical stirrer (anchor type) and with a receiver and heated by a thermally regulated Wood's alloy bath. After purging by 3 vacuum argon cycles, the medium is brought to 100° C. After starting to stir (60 revolutions/min), the temperature is increased to 250° C. over 30 minutes. After stirring at 250° C. for 6 h, the contents of the reactor are poured onto a Teflon polytetrafluoroethylene) sheet.

The linear sulfonated copolymer PEA4 exhibits a weight-average molar mass of 5570 g/mol, determined by gel permeation chromatography. Its analysis by ¹H NMR spectroscopy showed that it comprises polyamide 6 blocks with a mean degree of polymerization of 1.3, distributed 45% in the form of chain ends of type (V) and 55% in the form of “esteramide” units (I) and that the ratio by weight of the residues resulting from the sulfonated polyester (PES1) to the residues resulting from polyamide 6 in the copolymer PEA4 is 78/22.

### EXAMPLE V

The operation described in example IV is repeated, starting from 5.0 g of polyamide 6, 45.5 g of sulfonated polyester (PES1) and 50 mg of zinc acetate dihydrate.

The weight-average molar mass of the linear sulfonated copolymer PEAS obtained is 18 900 g/mol. The mean degree of polymerization of the polyamide 6 blocks is 1.40. The polyamide 6 blocks are distributed 45% in the form of chain ends of type (V) and 55% in the form of “esteramide” units (I) and the ratio by weight of the residues resulting from the sulfonated polyester (PES1) to the residues resulting from polyamide 6 in the copolymer PEAS is 91/9.

### EXAMPLE VI

Soil Release Properties

The soil release polymers to be tested are introduced into the detergent composition based on anionic surface-active agents for a washing machine of table 1 in a proportion of 1% by weight of active material of copolymer (C) according to the invention.

Test

Prewashing:

Squares with dimensions of 10×10 cm, made of
woven polyester with the finish removed three times with deionized water (4 test specimens, 12.5×10 cm)
knitted polyester (4 test specimens, 12.5×10 cm)
polyamide (4 test specimens, 12.5×10 cm),
   are prewashed in a Tergotometer for 20 minutes at 40° C. (agitation of 100 cycles/minute) with the detergent formulation of table 1 based on anionic surface-active agents comprising 1% by weight of active material of polymer to be tested; the water used exhibits a hardness of 30° HT (Contrexeville water); the amount of detergent employed is 5 g per 1 liter of water.

The squares of fabrics are subsequently rinsed 3 times for 5 minutes with faucet water and are then dried in an oven.

The reflectance R1 of the test specimens is measured using a reflectometer using the Dr. Lange/LUCI 100 calorimeter, according to the “L”, “a” and “b” system (scale from black to white, from green to red and from blue to yellow).
[R1=(L1²+a1²+b1²)^{1/2}]
Staining:

The prewashed test specimens are subsequently stained by depositing on each test specimen,
either 4 superimposed drops of dirty motor oil (DMO) in the middle of the test specimen
or 4 superimposed drops of soybean oil colored with violet dye in the middle of the test specimen,
   and, in order to ensure good attachment of the stain, the fabrics are dried in an oven.

The reflectance R2 of the test specimens after staining is measured, according to the “L”, “a” and “b” system.
[R2=(L2²+a2²+b2²)^{1/2}]
Washing:

6 test specimens (2 made of knitted polyester, 2 made of woven polyester and 2 made of polyamide) are washed separately according to the type of stain, this being carried out under the same conditions as those of the prewashing (at 40° C. for 20 minutes, using 5 g of detergent comprising 1% of active material of polymer per 1 liter of water of 30° HT, then 3 rinsings of 5 minutes with cold water and drying).

The reflectance R3 after washing the stained test specimens is measured, according to the “L”, “a” and “b” system.
[R3=(L3²+a3²+b3²)^{1/2}]
Evaluation

The effectiveness of the polymer tested as soil release agent with respect to the soybean oil stains colored by a violet dye is assessed by the % of removal of the stains, calculated by the formula
ΔE in %=100×(R3−R2)/(R1−R2)

The effectiveness of the polymer tested as soil release agent with respect to the dirty motor oil (DMO) stains is assessed by the % of removal of the stains, calculated by the formula
ΔL in %=100×(L3−L2)/(L1−L2)

The results obtained appear in table 1a and are compared with those obtained:
with the same detergent composition but devoid of copolymer (C)
with the same detergent composition but comprising, instead of the copolymer (C), the starting sulfonated polyester (PES1) not comprising “esteramide” units which is described above in example I.

It is found that, in a composition based on anionic surfactants, the copolymer (C) has an excellent performance as soil release agent toward dirty motor oil (DMO) on polyamide; this performance is better than that of the sulfonated polyester (PES1) of the prior art. Its performance is very similar to that of the sulfonated polyester (PES1) of the prior art toward violet dye, this being the case whether on polyamide or polyester.

### EXAMPLE VII

The soil release test described in example VI is repeated, the detergent composition for a washing machine which appears in table 2, based on a mixture of anionic and nonionic surface-active agents, being used. The results obtained appear in table 2a and are compared with those obtained:
with the same detergent composition but devoid of copolymer (C)
with the same detergent composition but comprising, instead of the copolymer (C), the starting sulfonated polyester (PES1) not comprising “esteramide” units which is described above in example I.

It was found that, in a composition based on a mixture of anionic and nonionic surfactants, the copolymer (C) has an excellent performance as soil release agent toward dirty motor oil (DMO) and violet dye on polyamide; this performance is better than that of the sulfonated polyester (PES1) of the prior art. Its performance is very similar to that of the sulfonated polyester (PES1) of the prior art toward violet dye on polyester.

TABLE 1

| Composition | Parts by weight |
|---|---|
| Zeolite 4A | 25 |
| Sodium disilicate | 5 |
| Sodium carbonate | 15 |
| Maleic/acrylic copolymer Sokalan CP5 | 5 |
| (BASF) | |
| Carboxymethylcellulose | 1 |
| Perborate monohydrate | 15 |
| Tetraacetylethylenediamine | 5 |
| Laurylbenzenesulfonate | 13 |
| Esperase 6T | 0.3 |
| Copolymer (C) | 1 |
| Sodium sulfate | q.s. for 100 |

TABLE 1a

| | Woven | Knitted | | |
|---|---|---|---|---|
| | polyester | polyester | Polyamide | |
| | Violet dye | Violet dye | DMO | Violet dye |
| Copolymer (C) | ΔE | ΔE | ΔL | ΔE |
| — | 35.8 | 30.2 | 61 | 82.7 |
| PEA1 | 99.5 | 97.8 | 73.1 | 81.9 |
| PEA2 | 99 | 99.8 | 68.2 | 82.3 |
| PEA3 | 98.5 | 98.1 | 66.3 | 85.3 |
| PEA4 | 98.1 | 99.2 | 74 | 84.1 |
| PEA5 | 98.5 | 99.5 | 68.8 | 82.5 |
| Sulfonated | 98.7 | 100 | 62.7 | 83 |
| polyester (PES1) | | | | |

TABLE 2

| | Parts by |
|---|---|
| Composition | weight |
| Zeolite 4A | 25 |
| Sodium disilicate | 5 |
| Sodium carbonate | 15 |
| Maleic/acrylic copolymer Sokalan CP5 (BASF) | 5 |
| Carboxymethylcellulose | 1 |
| Perborate monohydrate | 15 |
| Tetraacetylethylenediamine | 5 |
| Laurylbenzenesulfonate | 6 |
| Synperonic A3 (C₁₂-C₁₅ fatty alcohol ethoxylated | 3 |
| with 3 EO) | |
| Synperonic A9 (C₁₂-C₁₅ fatty alcohol ethoxylated | 9 |
| with 9 EO) | |
| Esperase 6T | 0.3 |
| Copolymer (C) | 1 |
| Sodium sulfate | q.s. for 100 |

TABLE 2a

| | Woven | Knitted | | |
|---|---|---|---|---|
| | polyester | polyester | Polyamide | |
| | Violet dye | Violet dye | DMO | Violet dye |
| Copolymer (C) | ΔE | ΔE | ΔL | ΔE |
| — | 1.5 | 28.8 | 78.9 | 78.9 |
| PEA2 | 99 | 99.8 | 90.1 | 92.4 |
| PEA3 | 98.5 | 98.7 | 93.9 | 91.8 |
| Sulfonated | 97.3 | 100 | 88 | 87.1 |
| polyester (PES1) | | | | |

1-26. (canceled)

27. A water-soluble or water-dispersible, linear sulfonated copolymer (C), comprising:
(i) linear polyesteramide chains (C₁), optionally linear polyester chains (C₂) and optionally polyamide chains (C₃),
(i1) said linear polyesteramide chains (C₁) being essentially composed of at least one “esteramide” unit of general formula (I)
[—C(O)-Q-C(O)—{NR′—W—C(O)}ₘ—(O—R—)ₙ—O—] (I)
wherein:
the symbol Q represents
a nonionic mono- or polyarylene or nonionic alkylene residue (NQ),
or a sulfonated mono- or polyarylene or sulfonated alkylene residue (SQ) carrying at least one sulfonic acid or sulfonate functional group,
R′ is H or an alkylene residue comprising from 1 to 4 carbon atoms,
W is a nonionic alkylene or nonionic arylene residue comprising from 1 to 20 carbon atoms
R is a linear or branched alkylene residue comprising from 2 to 4 carbon atoms,
m is equal to at least 1,
n ranges from 1 to 4;
and optionally of
at least one “ester” unit of general formula (II)
[—C(O)-Q-C(O)—(O—R—)ₙ—O—] (II)
wherein:
the symbols Q, R and n have the definition given above;
(i2 ) said optional linear polyester chains (C₂) having the general formula (III)
[—C(O)-Q-C(O)—(O—R—)ₙ—O—]ₓ (III)
wherein:
the symbols Q, R and n have the definition given above,
x is greater than 1,
the molar percentage of the groups of formula —C(O)-Q-C(O)— wherein Q is a sulfonated residue (SQ), with respect to the combined units of formula —C(O)-Q-C(O)— in the units or chains of formulae (I), (II) and (III), being from 5 to 40;
(i3 said optional polyamide chains (C₃) having the general formula (IV)
—{NR′—W—C(O)}_{z}— (IV)
wherein:
R′ and W have the definition given above,
z is greater than 1;
and (ii)
(ii1), as chain (C₁) ends,
an “amide” group of formula (V)
HO—[(O)C—W—NR′)—]ₚ (V)
wherein
the symbols W and R′ have the definition given above,
p is equal to at least 1;
and/or:
a group of formula (VI 1)
Z-(O—R)ₙ—O— (VI1)
wherein:
R and n have the definition given above,
Z represents
H,
a sulfobenzoyl group,
a sulfoalkyl group comprising from 2 to 30 carbon atoms,
a phenylsulfonate group;
and/or:
a group of formula (VII1)
Y—O— (VII1)
wherein Y represents H or an alkyl radical comprising from 1 to 30 carbon atoms, preferably methyl;
and/or:
a residue —Y, with the definition given above, bonded to an oxygen atom of an ether functional group of the chain (C₁);
(ii2), as chain (C₂) ends,
a group of formula (VI2)
Z-(O—R)ₙ—O— (VI2)
wherein:
R, Z and n have the definition given above;
and/or:
a group of formula (VII2)
Y—O— (VII2)
wherein Y has the definition given above;
and/or:
a residue —Y, with the definition given above, bonded to an oxygen atom of an ether functional group of the chain (C₂);
(ii3) and, as chain (C₃) ends,
a hydrogen atom bonded to a nitrogen atom of the chain (C₃);
and a functional group —OH bonded to a carbonyl residue —C(O)— of the chain (C₃);
said units of the chains (C₁) being:
bonded to one another or to the chain ends (ii1) of formulae (VI1)
and (VII1) by ester bonds;
bonded to the chain ends (ii1) of formula (V) by amide bonds;
the chain (C₂) being bonded to the chain ends (ii2) of formulae (VI2) and (VII2) by ester bonds;
the number of units of formulae (I) and (II) of the chains (C₁), the values of m, of p, of x and of z being such that the weight-average molar mass of said linear sulfonated copolymers (C) is from 500 to 80 000 g/mol; and
the value of m, of m+p, of m+z or of m+p+z, when one or more “amides” groups of formula (V) and/or one or more polyamide chains (C₃) are present, being such that the ratio of the number of —C(O)-Q-C(O)— groups to the number of —(NR′—W—C(O)— groups present in said linear sulfonated copolymers (C) is between 1/99 and 99/1.

28. The linear sulfonated copolymer (C) as claimed in claim 27, wherein the polyesteramide chains (C₁) are composed essentially of:
at least one unit of formula (I′)
[—C(O)-Q-C(O)—{NR′—W—C(O)}ₘ—(O—CH₂—CH₂—)ₙ—O—] (I′)
and, optionally of:
at least one unit of formula (II′)
[—C(O)-Q-C(O)—(O—CH₂—CH₂—)ₙ—O] (II′)

29. The linear sulfonated copolymer (C) as claimed in claim 28, wherein the groups of formula (V) above and/or of formula (VI′1)
H—(O—CH₂—CH₂—)ₙ—O (VI′1)
and/or a hydrogen atom H are present as chain (C₁) ends.

30. The linear sulfonated copolymer (C) as claimed in claim 27, wherein the optional polyester chains (C₂) have the general formula (III′)
[—C(O)-Q-C(O)—(O—CH₂—CH₂—)ₙ—O]ₓ (III′)

31. The linear sulfonated copolymer (C) as claimed in claim 30, wherein the groups of formula (VI′2)
H—(O—CH₂—CH₂—)ₙ—O (VI′2)
and/or a hydrogen atom H are present as chain (C₂) ends.

32. The linear sulfonated copolymer (C) as claimed in claim 28, wherein the molar percentage of the residues of formula (O—CH₂—CH₂—)ₙ wherein n is equal to 1, with respect to the combined residues of formula (O—CH₂—CH₂—)ₙ wherein n is equal to 1, 2, 3 and 4, in the units or end(s) of formulae (I′), (II′), (VI′1), (III)′) and (VI′2) is from 10 to 80.

33. The linear sulfonated copolymer (C) as claimed in claim 27, wherein the nonionic residues (NQ) of the units of formulae (I), (II) and (III) are nonionic C₆-C₁₄ mono- or polyarylene residues or linear or branched nonionic C₁-C₉ alkylene residues.

34. The linear sulfonated copolymer (C) as claimed in claim 33, wherein the nonionic residues (NQ) are 1,4-phenylene residues (NQ1) or 1,3-phenylene residues (NQ2).

35. The linear sulfonated copolymer (C) as claimed in claim 33, wherein the nonionic residues (NQ) of the units of formulae (I), (II) and (III) are 1,4-phenylene residues (NQ1) or a mixture of 1,4-phenylene residues (NQ1) and of 1,3-phenylene residues (NQ2), the molar percentage of the units of formula —C(O)-Q-C(O)— wherein Q is a residue (NQ1), with respect to the combined units of formula —C(O)-Q-C(O)— wherein Q is a nonionic residue (NQ), being from 50 to 100.

36. The linear sulfonated copolymer (C) as claimed in claim 27, wherein the sulfonated residues (SQ) of the units of formulae (I), (II) and (III) are sulfonated C₆-C₁₄ mono- or polyarylene residues or sulfonated, linear or branched, C₁-C₉ alkylene residues carrying at least one sulfonic acid fuctional group, optionally in the form of an alkali metal or tetraalkylammonium sulfonate.

37. The linear sulfonated copolymer (C) as claimed in claim 36, wherein the sulfonated residue (SQ) is a 5-(sodiooxysulfonyl)-1,3-phenylene residue.

38. The linear sulfonated copolymer (C) as claimed in claim 27, wherein the symbol W in the formulae (I), (I′), (IV) and (V) represents an ethylene, trimethylene, tetramethylene, pentamethylene, heptamethylene, decamethylene, undecamethylene or phenylene residue.

39. The linear sulfonated copolymer (C) as claimed in claim 27, wherein the symbol R′ in the formulae (I), (I′), (IV) and (V) represents H.

40. A process for the preparation of the linear sulfonated copolymer (C) as defined in claim 27, comprising the steps of:
1) carrying out an insertion/polymerization reaction, in the presence of an insertion/polymerization catalyst, or
2) carrying out an aminolysis/acidolysis/polycondensation reaction, in the presence of an aminolysis/acidolysis/polycondensation catalyst, or
3) carrying out an ester/amide exchange reaction, in the presence of an ester/amide exchange catalyst, in a molten medium
(a)—of at least one amino acid or poly(amino acid) (“polyamide”) of formula (VIII) or corresponding lactam
H—[NR′—W—C(O)—]_{q}OH (VIII)
wherein:
W and R′ have the definition given above,
Q ranges from 1 to 200;
(b)—with a linear sulfonated polyester comprising
(b1) a polyester chain of general formula (IX)
[—C(O)-Q-C(O)—(O—R—)ₙ—O]_{y} (IX)
wherein:
the symbol Q represents
a nonionic mono- or polyarylene or nonionic alkylene residue (NQ),
or a sulfonated mono- or polyarylene or sulfonated alkylene residue (SQ) carrying at least one sulfonic acid or sulfonate functional group,
R is a linear or branched alkylene residue comprising from 2 to 4 carbon atoms, *n ranges from 1 to 4,
y is greater than 1;
and
(b2), as chain ends, groups of formula (VI2) and/or (VII2) and/or Y given above,
with a molar percentage of the groups of formula —C(O)-Q-C(O)— wherein Q is a sulfonated residue (SQ), with respect to the combined groups of formula —C(O)-Q-C(O)— in the units of formula (VIII), being from 5 to 40;
the values of n and y being such that the weight-average molecular mass of said polyester is greater than 1500 g/mol; and
the relative amounts of amino acid, poly(amino acid) of formula (VIII) or lactam and of linear sulfonated polyester being such that the ratio of the number of —C(O)-Q-C(O)— groups employed via said linear sulfonated polyester to the number of —(NR′—W—C(O)— groups employed via said amino acid or poly(amino acid) of formula (VIII) or lactam is between 1/99 and 99/1.

41. The process as claimed in claim 40, wherein the amino acids, poly(amino acid)s or lactams are:
β-propiolactam, γ-butyrolactam, δ-valerolactam, ε-caprolactam, η-caprylolactam, the lactam of ω-aminoundecanoic acid, and the corresponding amino acids, para- and meta-aminobenzoic acids, or
polyamide 6, polyamide 8, polyamide 12, and their copolymers, with a degree of polymerization ranging from 2 to 200.

42. The process as claimed in claim 40, wherein the linear sulfonated polyester comprises:
a polyester chain of general formula (IX′)
[—C(O)-Q-C(O)—(O—CH₂—CH₂—)ₙ—O]_{y} (IX′)
and, as chain ends, groups of formula (VI′2)
H—(O—CH₂—CH₂—)ₙ—O— (VI′2)
and H.

43. The process as claimed in claim 42, wherein the residues of formula (O—CH₂—CH₂—)ₙ wherein n is equal to 1, present a molar percentage with respect to the combined residues of formula (O—CH₂—CH₂—)ₙ wherein n is equal to 1, 2, 3 and 4, in the chains or end(s) of formulae (IX′) and (VI′2), of from 10 to 80.

44. A composition for the treatment of articles made of textile fibers, intended to be employed in an operation in which said articles are washed and/or rinsed, prespotted, dried in a tumble dryer or ironed, comprising from 0.01 to 70%, with respect to the weight of said compositions, of at least one water-soluble or water-dispersible linear sulfonated copolymer (C) as defined in claim 27.

45. The composition as claimed in claim 44, being provided:
in the form of a solid or of a concentrated aqueous solution or dispersion brought into contact with the articles to be treated after dilution in water;
in the form of a concentrated aqueous solution or dispersion deposited beforehand on the dry articles to be treated before dilution in water;
in the form of an aqueous solution or dispersion to be deposited directly on the dry articles to be treated without dilution or of a solid support comprising said linear sulfonated copolymer (C) to be applied directly to the dry articles to be treated; or
in the form of an insoluble solid support comprising said linear sulfonated copolymer (C) brought directly into contact with the articles to be treated in the wet state.

46. The composition as claimed in claim 44, wherein said composition is:
a solid or liquid detergent formulation comprising from 0.01 to 10%, of said copolymer (C), expressed on a dry basis, capable of directly forming a detergent bath by dilution;
a liquid rinsing formulation comprising from 0.01 to 10%, of said copolymer (C), expressed on a dry basis, capable of directly forming a rinsing bath by dilution; a solid material, optionally a textile material, comprising from 0.01 to 70%, of said copolymer (C), expressed on a dry basis, intended to be brought into contact with wet articles in a tumble dryer;
an aqueous ironing formulation comprising from 0.01 to 50%, of said copolymer (C), expressed on a dry basis; or
a prespotter comprising from 0.01 to 10%, of said copolymer (C), expressed on a dry basis, intended to be deposited on dry articles prior to a washing operation using a detergent formulation, optionally comprising said linear sulfonated copolymer (C).

47. The composition as claimed in any one of claims 44, wherein said composition further comprises at least one surface-active agent and/or one detergency and/or rinsing and/or ironing additive for articles made of textile fibers and/or one solid support for said copolymer (C).

48. A process for improving the properties of a composition intended for washing and/or rinsing, prespotting, drying in a tumble dryer or ironing said articles made of textile fibers said process comprising the step of adding to said composition at least one linear sulfonated copolymer (C) as defined in claim 27, in an amount which is effective in contributing soil release and/or antiredeposition and/or detergency properties to said compositions.

49. The process as claimed in claim 48, wherein the amount of linear sulfonated copolymer (C) is from 0.01 to 70%, with respect to the weight of said compositions.

50. The process as claimed in claim 48, wherein said composition is:
a solid or liquid detergent formulation comprising from 0.01 to 10%, of said copolymer (C), expressed on a dry basis, capable of directly forming a detergent bath by dilution;
a liquid rinsing formulation comprising from 0.01 to 10%, of said copolymer (C), expressed on a dry basis, capable of directly forming a rinsing bath by dilution; a solid material, optionally a textile material, comprising from 0.01 to 70%, of said copolymer (C), expressed on a dry basis, intended to be brought into contact with wet articles in a tumble dryer;
an aqueous ironing formulation comprising from 0.01 to 50%, of said copolymer (C), expressed on a dry basis; or
a prespotter comprising from 0.01 to 10%, of said copolymer (C), expressed on a dry basis, intended to be deposited on dry articles prior to a washing operation using a detergent formulation which may or may not comprise said linear sulfonated copolymer (C).
